(19) United States
(12) Patent Application Publication
(10) Pub. No.: US 2016/0021212 A1
(43) Pub. Date: Jan. 21, 2016

(54) METHOD, SERVER AND CLIENT DEVICE FOR UPDATING SERVICE REGISTRATION

(71) Applicant: Xiaomi Inc., Beijing (CN)

(72) Inventors: Yi Gao, Beijing (CN); Hongqiang Wang, Beijing (CN); Hai Long, Beijing (CN)

(21) Appl. No.: 14/634,905

(22) Filed: Mar. 2, 2015

Related U.S. Application Data
(63) Continuation of application No. PCT/CN2014/091420, filed on Nov. 18, 2014.

(30) Foreign Application Priority Data
Jul. 16, 2014 (CN) 201410340318.4

(51) Int. Cl. H04L 29/08

(52) U.S. Cl. CPC H04L 67/306; H04L 67/327

(57) ABSTRACT

A method, server and client device for updating service registration are provided. The method includes: receiving a first service registration updating request from a client device; acquiring services registered by a first contact identification of the client device; and updating registration information of service using a second contact identification of the client device. The present disclosure may ensure users to easily update registered services after replacing contact identification, thus improving user experience.

### CROSS-REFERENCE TO RELATED APPLICATIONS

This application is a Continuation Application of International Application No. PCT/CN2014/091420, filed on Nov. 18, 2014, based on and claims priority to Chinese Patent Application No. 201410340318.4, filed on Jul. 16, 2014, the entire contents of which are incorporated herein by reference.

### TECHNICAL FIELD

The present disclosure generally relates to the field of Internet, and more particularly, to a method, a server and a client device for updating service registration.

### BACKGROUND

Generally users need to use contact identification (for example, mobile phone number) for registering services provided by websites or other institutions.

### SUMMARY

According to a first aspect of the embodiments of the present disclosure, there is provided a method for updating a service registration on a server, comprising: receiving a first service registration updating request from a client device; acquiring services registered with a first contact identification of the client device; and updating registration information of the services using a second contact identification of the client device.

According to a second aspect of the embodiments of the present disclosure, there is provided a method for updating a service registration on a client device, comprising: monitoring a triggering event for service registration updating; sending a first service registration updating request to a server; receiving from the server a service list, in which services, corresponding to service registration messages received from the client device via a first contact identification and synchronized to the server, are recorded; and sending a second service registration updating request to providers of the services recorded in the service list, wherein the second service registration updating request carries a second contact identification of the client device.

According to a third aspect of the embodiments of the present disclosure, there is provided a server, comprising: a processor; and a memory configured to store instructions executable by the processor, wherein the processor is configured to perform: receiving a first service registration updating request from a client device; acquiring services registered with a first contact identification of the client device; and updating registration information of the services using a second contact identification of the client device.

According to the forth aspect of the embodiments of the present disclosure, there is provided a client device, comprising: a processor; and a memory configured to store instructions executable by the processor; wherein, the processor is configured to perform: monitoring a triggering event for service registration updating; sending a first service registration updating request to a server; receiving from the server a service list, in which services, corresponding to service registration messages received from the client device via a first contact identification and synchronized to the server, are recorded; and sending a second service registration updating request to providers of the services recorded in the service list, wherein the second service registration updating request carries a second contact identification of the client device.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for updating a registration according to an exemplary embodiment.

FIG. 2 is a flow chart showing a method for updating a registration according to an exemplary embodiment.

FIG. 3 is a flow chart showing a method for updating a registration according to an exemplary embodiment.

FIG. 4 is a flow chart showing a method for updating a registration according to an exemplary embodiment.

FIG. 5 is a schematic diagram showing an apparatus for updating a registration according to an exemplary embodiment.

FIG. 6 is a schematic diagram showing an apparatus for updating a registration according to an exemplary embodiment.

FIG. 7 is a schematic diagram showing a server according to an exemplary embodiment.

FIG. 8 is a schematic diagram showing a client device according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

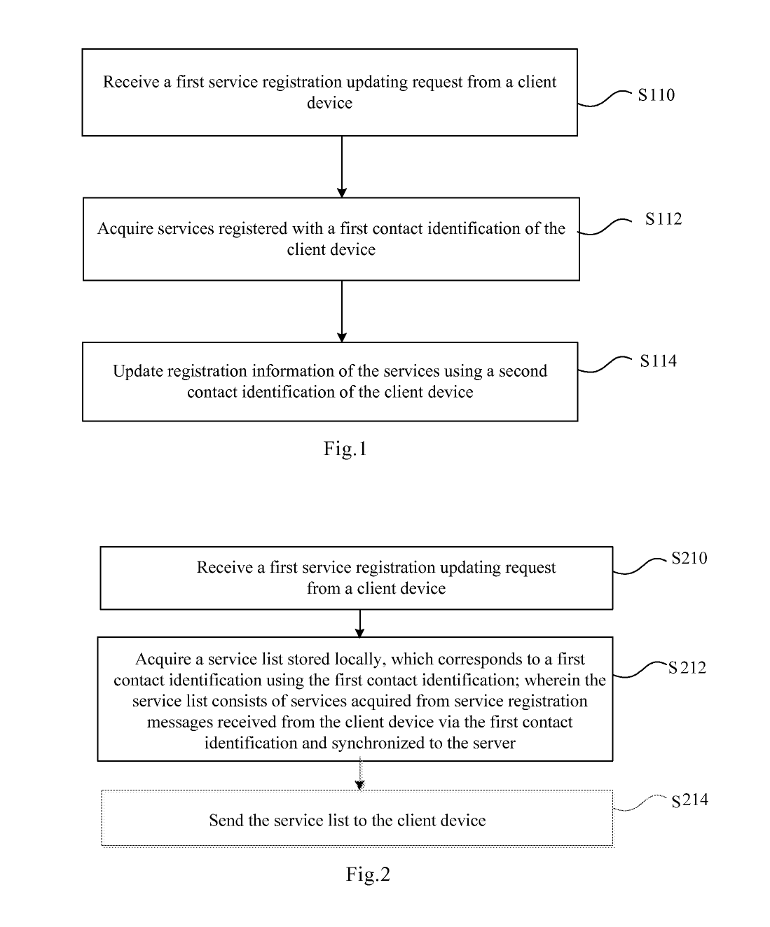

FIG. 1 is a flow chart showing a method for updating a registration according to an exemplary embodiment, the method for updating the registration is implemented by a server, including following steps.

In Step S110, a first service registration updating request from a client device is received.

In Step S112, services registered with a first contact identification of the client device are acquired.

In Step S114, registration information of the services is updated using a second contact identification of the client device.

For example, the first contact identification may be a number of a user's old mobile phone, the second contact identification may be a number of a user's new mobile phone, and the client device may be either a user's mobile phone, or a smart product such as a PC or a tablet computer. In the embodiment, users may relatively easily update registered services after changing contact identification, thus improving user experience.

As an optional implementing manner, Step S112 may include: acquiring a service list stored locally, which corresponds to the first contact identification using the first contact identification; wherein the service list includes services acquired from service registration messages received from the client device via the first contact identification and synchronized to the server.

At present, in order to use services, generally users need to use a mobile phone number for registration to a service provider, who usually provides users with a service registration message, which may carry a verification code or may just indicate the registration successful, with a concrete form not limited herein. For example, the service registration message herein may be a short message for service registration.

FIG. 2 is a flow chart showing a method for updating a registration according to an exemplary embodiment, and the method for updating the registration is implemented by a server, including following steps.

In Step S210, a first service registration updating request from a client device is received.

In Step S212, a service list stored locally, which corresponds to the first contact identification is acquired using the first contact identification; wherein the service list includes services acquired from service registration messages received from the client device via the first contact identification and synchronized to the server.

After users use certain services using contact identification registration, the received message such as verification codes and information notices are analyzed by a client device used by users. These messages may be determined as service registration messages because they are associated with services provided by some institutions through user contact identification and even used as registration ID. The client device used by users may synchronize service registration messages to a server, which may acquire services from the service registration messages and add services into a service list.

In Step S214, the service list is sent to the client device.

In the embodiment, when a client device has demand for the service registration update, a server will sort out a service list required for the client device and send it to the client device so that the client device may execute the service registration update according to the service list provided by the server, saving for users to conduct themselves the step of searching for and sorting out services in need of executing the service registration update, thus simplifying user operation.

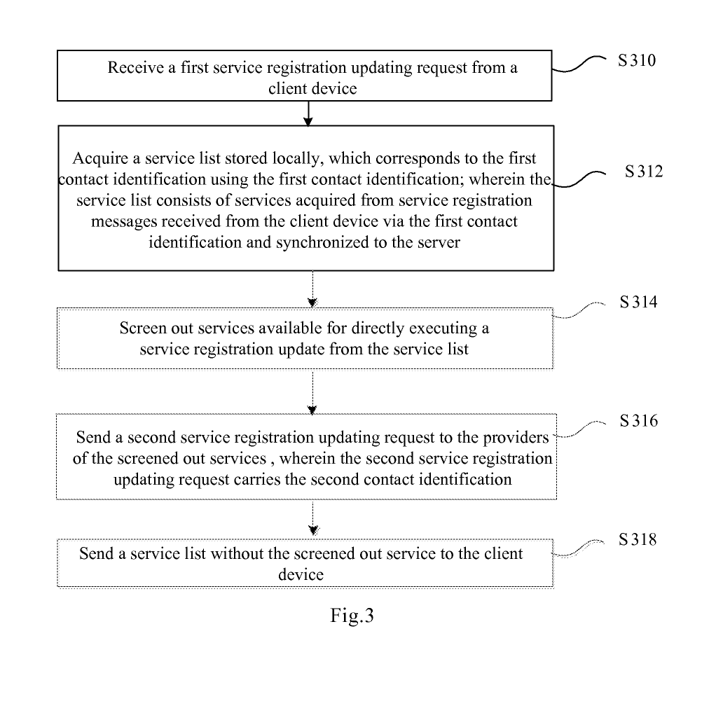

FIG. 3 is a flow chart showing a method for updating a registration according to an exemplary embodiment, and the method for updating the registration is implemented by a server, including following steps.

In Step S310, a first service registration updating request from a client device is received.

In Step S312, a service list stored locally, which corresponds to the first contact identification is acquired using the first contact identification; wherein the service list includes services acquired from service registration messages received from the client device via the first contact identification and synchronized to the server.

After users use certain services using contact identification registration, the received message such as verification codes and information notices are analyzed by a client device used by users. These messages may be determined as service registration messages because they are associated with services provided by some institutions through user contact identification and even used as registration ID. The client device used by users may synchronize service registration messages to a server, which may acquire services from the service registration messages and add services into a service list.

In Step S314, services available for directly executing a service registration update are screened out from the service list.

As an optional implementing manner, the screening out, from the service list, services available for directly executing the service registration update may include following substeps.

In substep 1, the type of each service in the service list is traversed through beginning from the first service in the service list.

In substep 2, services with types indicating “available for directly executing the service registration update” are screened out.

The type available for directly executing the service registration update may be marked according to a notation by the client device on the service registration message when services are acquired by the server from service registration messages received from the client device via the first contact identification and synchronized to the server. For example, to a certain service registration message, the notation of the client device is “Alipay”. As it is involved with personal privacy information relating to financial affairs, this service registration message may be labeled as “unavailable for directly executing the service registration update”, i.e., users need to execute the service registration update by themselves. For another example, to a certain service registration message, the notation of the client device is “general information retrieval organization”. As it is not involved with any privacy information, this service registration message may be labeled as “available for directly executing the service registration update”, i.e., the server may directly execute the service registration update for users. It may be preset that what type of rules is labeled on the basis of what kind of notation.

As another optional implementing manner, screening out the services available for directly executing the service registration update may include following substeps.

In substep 1′, providers of each service in the service list are traversed through beginning from the first service in the service list.

In substep 2′, services corresponding to providers in the list available for directly executing the service registration update are screened out.

Under the circumstances, the client device may not make notation when in synchronizing service registration message. If the client device needs the service registration update, the server may analyze providers of each service by itself, and then query providers from such a preset list as being available for directly executing the service registration update. If a provider of a certain service is listed in the list, this service is available for directly executing the service registration update, i.e., users does not need to execute the service registration update by themselves.

In Step S316, a second service registration updating request is sent to providers of the screened out services, wherein the second service registration updating request carries the second contact identification.

In Step S318, a service list without the screened out services is sent to the client device.

In Step S318, as an optional implementing manner, a confirmation notice is sent to a client device, wherein the confirmation notice prompts that a server will execute the service registration update of services available for directly executing the service registration update; after a confirmation instruction of the confirmation notice from the client device is received, a step of sending a second service registration updating request to the providers of the services screened out is executed.

In the embodiment, when a client device has demand for the service registration update, the client device differentiates types of services, wherein a part of services may be subject to the service registration update directly by the server, while the other part of services are sent to the client device via a service list so that the client device may execute the service registration update according to the service list provided by the server, saving for users to conduct themselves the step of searching for and sorting out services in need of executing the service registration update, also a part of services may be directly sent by the client device to the server for executing the service registration update, thus simplifying user operation.

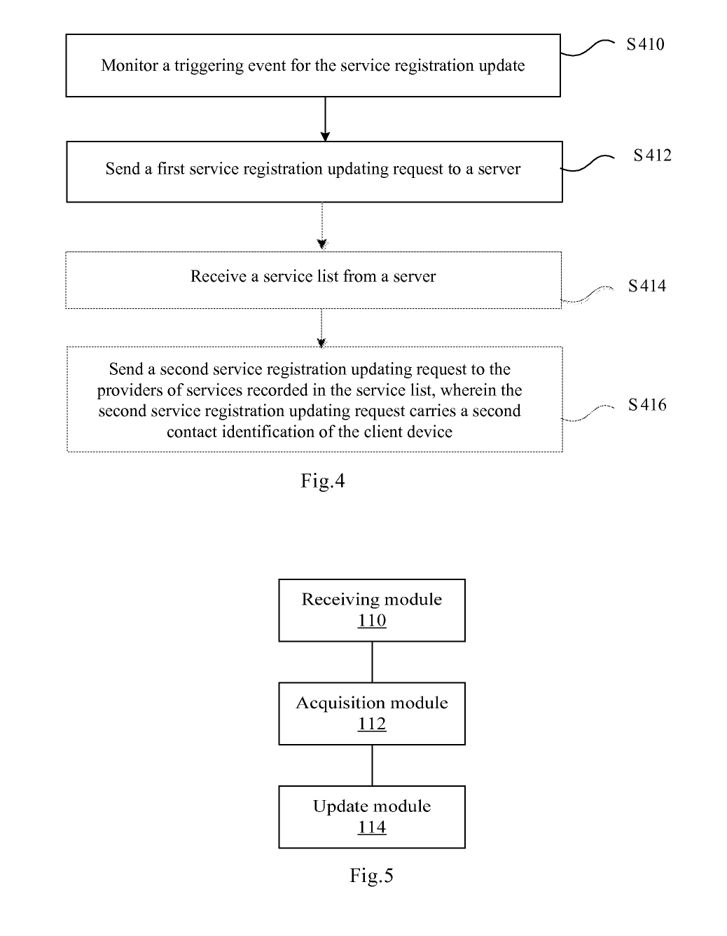

FIG. 4 is a flow chart showing a method for updating a registration according to an exemplary embodiment, the method is implemented by a client device, including following steps.

In Step S410, a triggering event for service registration updating is monitored.

In Step S412, a first service registration updating request is sent to a server.

In Step S414, a service list from the server is received.

In the service list, services, corresponding to service registration messages received from the client device via a first contact identification and synchronized to the server, are recorded.

In Step S416, a second service registration updating request is sent to providers of services recorded in the service list, wherein the second service registration updating request carries a second contact identification of the client device.

For example, the first contact identification may be a number of a user's old mobile phone, the second contact identification may be a number of a user's new mobile phone, and the client device may be either a user's mobile phone, or a smart product such as a PC or a tablet computer. In the embodiment, users may relatively easily update registered services after changing contact identification, thus improving user experience.

As an optional implementing manner, when a second service registration updating request is sent to providers of services recorded in a service list, the service list is presented to users, and an execution instruction inputted by users is received; users may select, on the service list presented, services to be executed the service registration update. After the execution instruction is received, a second service registration updating request is sent to the providers of services recorded in the service list.

In the embodiment, users may quickly and clearly query, from a service list received by the client device, services in need of the registration update, no longer needing to browse a short message list item by item, thus improving user experience. For example, after users change contact identification, it is easy to uniformly re-register services registered in old contact identification, thus improving user experience.

As an optional implementing manner, the embodiment may also include: receiving a confirmation notice from a server, wherein the confirmation notice prompts that the server will execute a service registration update of services available for directly executing the service registration update; and sending a confirmation instruction of the confirmation notice to the server.

In the embodiment, automatic registration of services saving for users to conduct themselves manual registration may be completed by the server upon user authorization, which further reduces workload of uniform re-registration after users change contact identification, thus greatly improving user experience.

As an optional implementing manner, the method may also include: receiving messages via the first contact identification; selecting a message, which records services from the messages, as a service registration message; and synchronizing the service registration message to the server using the first contact identification.

FIG. 5 is a schematic diagram showing an apparatus for updating a service registration according to an exemplary embodiment, the apparatus is implemented by a server, including: a receiving module 110, configured to receive a first service registration updating request from a client device; an acquisition module 112, configured to acquire services registered with a first contact identification of the client device; and an update module 114, configured to update registration information of the services using a second contact identification of the client device.

For example, the first contact identification may be a number of a user's old mobile phone, the second contact identification may be a number of a user's new mobile phone, and the client device may be either a user's mobile phone, or a smart product such as a PC or a tablet computer. In the embodiment, users may relatively easily update registered services after changing contact identification, thus improving user experience.

As an optional implementing manner, the acquisition module 112 is configured to acquire a service list stored locally, which corresponds to the first contact identification using the first contact identification; wherein the service list consists of services acquired from service registration messages received from the client device via the first contact identification and synchronized to the server.

On this basis, the update module 114 is configured to send the service list to the client device.

In the embodiment, when a client device has demand for the service registration update, a server will sort out a service list required for the client device and send it to the client device so that the client device may execute the service registration update according to the service list provided by the server, saving for users to conduct themselves the step of searching for and sorting out services in need of executing the service registration update, thus simplifying user operation. For example, after users change contact identification, it is easy to uniformly re-register services registered in old contact identification, thus improving user experience.

As an optional implementing manner, the acquisition module 112 is configured to acquire a service list stored locally, which corresponds to the first contact identification using the first contact identification; wherein the service list consists of services acquired from service registration messages received from the client device via the first contact identification and synchronized to the server.

On this basis, the update module 114 may include: a screening submodule, a first sending submodule and a second sending submodule.

The screening submodule is configured to screen out services available for directly executing a service registration update from the service list.

The first sending submodule is configured to send a second service registration updating request to providers of the screened out services, wherein the second service registration updating request carries the second contact identification.

The second sending submodule is configured to send a service list without the screened out service to the client device.

Further, the screening submodule is configured to traverse through the type of each service in the service list beginning from the first service in the service list; and screen out services types of which indicate “available for directly executing the service registration update”.

Or further, the screening submodule is configured to traverse through providers of each service in the service list beginning from the first service in the service list, and screen out services corresponding to providers in the list available for directly executing the service registration update.

Or further, the update module also includes: a triggering submodule, configured to: send a confirmation notice to the client device; receive a confirmation instruction of the confirmation notice from the client device; and trigger the second sending submodule to execute operation after receiving the confirmation instruction. Wherein, the confirmation notice prompts that the service registration update of the services available for directly executing the service registration update will be executed.

Therefore, registration services relating to registered short messages are classified herein. Only those services compulsory for manual registration are added into a service list and presented to users, then users need manually complete concrete registration updating operation themselves. As for those services available for directly requesting updating registration by a server, registration updating requests are directly sent by the server to service organizations. In this way, the service list is simplified, and services required for the registration update by users manually are reduced, thus further improving user experience.

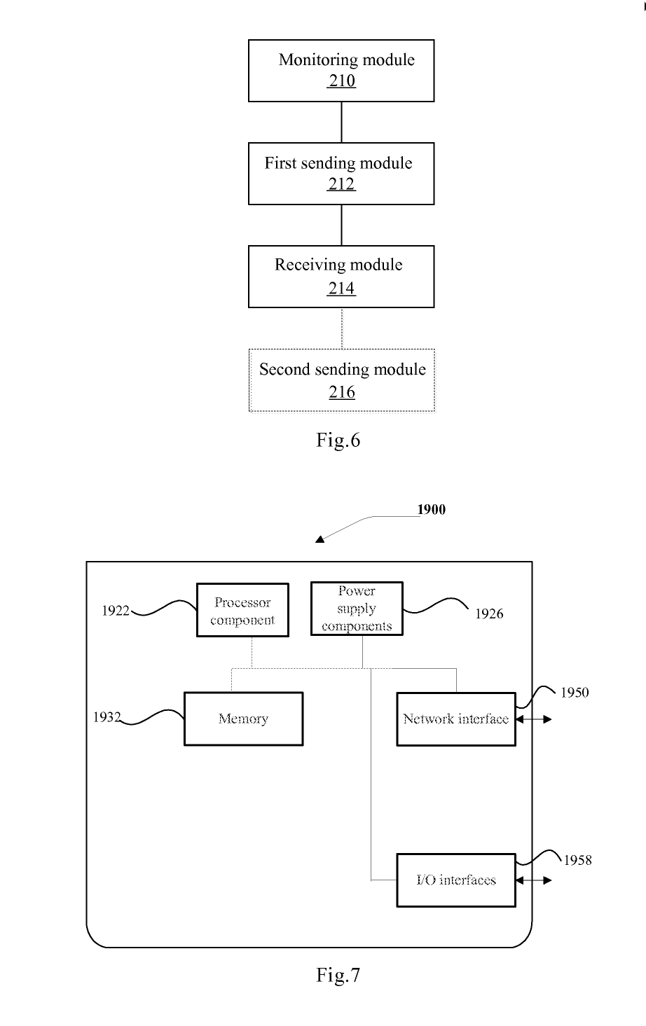

FIG. 6 is a schematic diagram showing an apparatus for updating service registration according to an exemplary embodiment, the apparatus is included in a client device, including: a monitoring module 210, configured to monitor a triggering event for service registration updating; a first sending module 212, configured to send a first service registration updating request to a server; a receiving module 214, configured to receive from the server a service list, in which services, corresponding to service registration messages received from the client device via a first contact identification and synchronized to the server are recorded; and a second sending module 216, configured to send a second service registration updating request to providers of services recorded in the service list, wherein the second service registration updating request carries a second contact identification of the client device.

In the embodiment, users may relatively easily update registered services after changing contact identification, thus improving user experience.

As an optional implementing manner, the second sending module 216 may include: a presentation submodule, a receiving submodule and an execution submodule.

The presentation submodule is configured to present the service list.

The receiving submodule is configured to receive an execution instruction inputted by users.

The execution submodule is configured to send, after the execution instruction is received by the receiving submodule, a second service registration updating request to the providers of the services recorded in the service list.

As another optional implementing manner, the apparatus may also include: a notice receiving module, configured to receive a confirmation notice from a server, the confirmation notice prompts that the server will execute the service registration update of services available for directly executing the service registration update; and a confirmation sending module, configured to send a confirmation instruction of the confirmation notice to the server.

In the optional implementing manner, automatic registration of services saving for users to conduct themselves manual registration may be completed by the server upon user authorization, which further reduces workload of uniform re-registration after users change contact identification, thus greatly improving user experience.

As a third optional implementing manner, the apparatus may also include: a message receiving module, configured to receive messages via the first contact identification; a selection module, configured to select, from the messages a message having recorded services as a service registration message; and a synchronization module, configured to synchronize the service registration message to the server using the first contact identification.

FIG. 7 is a block diagram showing a server according to an exemplary embodiment. Referring to FIG. 7, a server 1900 includes a processor component 1922, and further includes one or a plurality of processors, and memory resource represented by a memory 1932 and configured to store instructions that can be executed by the processor component 1922, for example, application program. The application program stored in the memory 1932 may include one or a plurality of modules each of which is corresponding to a set of instructions. In addition, the processor component 1922 is configured to execute instructions so as to execute the foregoing method of the server.

The server 1900 may also include one or a plurality of power supply components 1926 configured to execute the power management of the server 1900, one or a plurality of wired or wireless network interface 1950 configured to connect the server 1900 to the network, and one or a plurality of input/output (I/O) interfaces 1958, one or a plurality of keyboards 1956, and/or one or a plurality of operating systems 1941. The server 1900 may operate an operating system based on and stored in the memory 1932, for example, Windows Server™, Mac OS X™, Unix™, Linux™, FreeBSD™ or other similar operating systems.

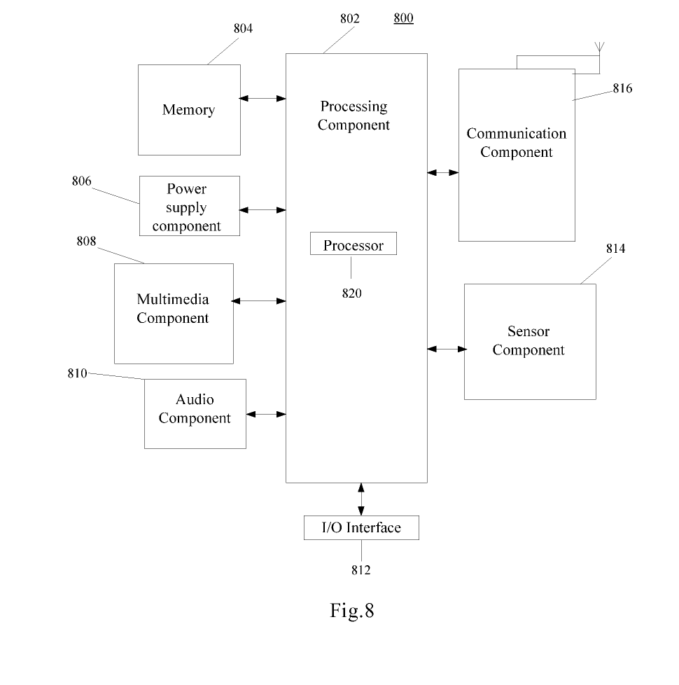

FIG. 8 is a block diagram showing a client device according to an exemplary embodiment. For example, the client device 800 may be a mobile telephone, a computer, a digital broadcasting terminal, a message transceiver device, a games console, a tablet device, a medical device, a fitness facility, a PDA (personal digital assistant) and the like.

Referring to FIG. 8, the client device 800 may include one or a plurality of components:

a processor component 802, a memory 804, a power supply component 806, a multimedia component 808, an audio component 810, an input/output (I/O) interface 812, a sensor component 814 and a communication component 816.

The processor component 802 usually controls the overall operation of the client device 800, for example, display, telephone call, data communication, and operation associated with camera operation and record operation. The processor component 802 may include one or a plurality of processors 820 for executing instructions so as to complete steps of the method of the above client device in part or in whole. In addition, the processor component 802 may include one or a plurality of modules for the convenience of interaction between the processor component 802 and other components. For example, the processor component 802 may include a multimedia module for the convenience of interaction between the multimedia component 808 and the processor component 802.

The memory 804 is configured to store data of different types so as to support the operation of the client device 800. Examples of the data include any application program or approach directive for operation of the client device 800, including contact data, phonebook data, message, picture and video, etc. The memory 804 may be realized by volatile or non-volatile memory device of any type or combination thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The power supply component 806 provides power for components of the client device 800. The power supply component 806 may include a power management system, one or a plurality of power supplies, and other components associated with generation, management and power distribution of the client device 800.

The multimedia component 808 includes a screen between the client device 800 and a user and for providing an output interface. In some embodiments, the screen may include an LCD (Liquid Crystal Display) and a touch panel (TP). If the screen includes a touch panel, the screen may be realized as a touch screen for receiving input signal from users. The touch panel includes one or a plurality of touch sensors for sensing gestures on the touch panel, for example, touching and sliding, etc. The touch sensor not only can sensor trip boundary of touching or sliding, but also can detect the duration and pressure related to the touching or sliding operation. In some embodiments, the multimedia component 808 includes a front-facing camera and/or a rear-facing camera. When the client device 800 is under an operation mode, for example, capture mode or video mode, the front-facing camera and/or the rear-facing camera may receive external multimedia data. Each front-facing camera and rear-facing camera may be a fixed optical lens system or have focal length and optical zoom capacity.

The audio component 810 is configured to output and/or input audio signal. For example, the audio component 810 includes a microphone (MIC); when the client device 800 is under an operation mode such as a call mode, a record mode and a speech recognition mode, the microphone is configured to receive external audio signal. The audio signal received may be further stored in the memory 804 or sent out by the communication component 816. In some embodiments, the audio component 810 also includes a loudspeaker for outputting audio signal.

The I/O interface 812 provides interface for the processor component 802 and peripheral interface modules, the peripheral interface modules may be a keyboard, a click wheel and buttons, etc. These buttons may include but not limited to: a home button, a volume button, a start button and a locking button.

The sensor component 814 includes one or a plurality of sensors for providing the client device 800 with state evaluation from all aspects. For example, the sensor component 814 may detect the on/off state of the client device 800, relative positioning of components, for example, the components are the displayer and keypads of the client device 800; the sensor component 814 also may detect the position change of the client device 800 or a component thereof, the presence or absence of users' touch on the client device 800, the direction or acceleration/deceleration of the client device 800, and temperature variation of the client device 800. The sensor component 814 may also include a proximity detector, which is configured to detect the presence of nearby objects in case of no physical touch. The sensor component 814 may also include an optical sensor, for example, CMOS or CCD image sensor for imaging. In some embodiments, the sensor component 814 may also include an acceleration sensor, a gyro sensor, a magnetic sensor, a pressure sensor, or a temperature sensor.

The communication component 816 is configured to facilitate wired communication or wireless communication between the client device 800 and other equipment. The client device 800 is available for access to wireless network based on communication standards such as WiFi, 2G or 3G, or combination thereof. In an exemplary embodiment, the communication component 816 receives by means of a broadcast channel the broadcast signal or broadcast-related information from external broadcast management systems. In an exemplary embodiment, the communication component 816 also includes a near field communication (NFC) module for promoting short-range communication. For example, the NFC module may be realized on the basis of Radio Frequency Identification (RFID) Technology, Infrared Data Association (IrDA) Technology, Ultra-wide Bandwidth (UWB) Technology, Bluetooth (BT) Technology and other technologies.

In exemplary embodiments, the client device 800 may be realized by one or a plurality of application specific integrated circuits (ASIC), digital signal processors (DSP), digital signal processing equipment (DSPD), programmable logic devices (PLD), field programmable gate arrays (FPGA), controllers, microcontrollers, microprocessors or other electronic components, configured to execute the above methods.

In exemplary embodiments, a non-transitory computer-readable storage medium including instructions is also provided, for example, a memory 804 including instructions, above instructions may be executed by the processors 820 of the client device 800 so as to achieve the method of the above client device. For example, the non-transitory computer-readable storage medium may be ROM, random access memory (RAM), CD-ROM, magnetic tape, floppy disk and optical data storage device, etc.

The embodiments of the present disclosure provide a communication system, including the foregoing server and the client device.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for updating a service registration on a server, comprising:
receiving a first service registration updating request from a client device;
acquiring services registered with a first contact identification of the client device; and
updating registration information of the services using a second contact identification of the client device.

2. The method of claim 1, wherein acquiring the services registered with the first contact identification of the client device comprises:
acquiring a service list stored locally, which corresponds to the first contact identification using the first contact identification; wherein the service list comprises services acquired from service registration messages received from the client device via the first contact identification and synchronized to the server.

3. The method of claim 2, wherein updating the registration information of the services using the second contact identification of the client device comprises:
sending the service list to the client device.

4. The method of claim 2, wherein updating the registration information of the services using the second contact identification of the client device comprises:
screening out, from the service list, services available for directly executing a service registration update;
sending a second service registration updating request to providers of the screened out services, wherein the second service registration updating request carries the second contact identification; and
sending a service list without the screened out services to the client device.

5. The method of claim 4, wherein screening out the services available for directly executing the service registration update comprises:
traversing through a type of each service in the service list beginning from the first service in the service list; and
screening out services belonging to types available for directly executing the service registration update,
wherein the type available for directly executing the service registration update is marked according to a notation by the client device on the service registration message when services are acquired from service registration messages received from the client device via the first contact identification and synchronized to the server.

6. The method of claim 4, wherein screening out the services available for directly executing the service registration update comprises:
traversing through providers of each service in the service list beginning from the first service in the service list; and
screening out services corresponding to providers in a list available for directly executing the service registration update.

7. The method of claim 4, wherein updating the registration information of the services using the second contact identification of the client device further comprises:
sending a confirmation notice to the client device, wherein the confirmation notice prompts that the service registration update of the services available for directly executing the service registration update will be executed;
receiving a confirmation instruction of the confirmation notice from the client device; and
executing, after receiving the confirmation instruction, a step of sending a second service registration updating request to the providers of the services screened out.

8. A method for updating a service registration on a client device, comprising:
monitoring a triggering event for service registration updating;
sending a first service registration updating request to a server;
receiving from the server a service list, in which services, corresponding to service registration messages received from the client device via a first contact identification and synchronized to the server, are recorded; and
sending a second service registration updating request to providers of the services recorded in the service list, wherein the second service registration updating request carries a second contact identification of the client device.

9. The method of claim 8, wherein sending the second service registration updating request to the providers of the services recorded in the service list comprises:
presenting the service list;
receiving an execution instruction inputted by users; and
sending the second service registration updating request to the providers of the services recorded in the service list.

10. The method of claim 8, wherein the method further comprises:
receiving a confirmation notice from the server, wherein the confirmation notice prompts that the server will execute a service registration update of services available for directly executing the service registration update; and
sending a confirmation instruction of the confirmation notice to the server.

11. The method of claim 8, wherein the method further comprises:
receiving messages via the first contact identification;
selecting a message, which records services from the messages, as a service registration message; and
synchronizing the service registration message to the server using the first contact identification.

12. A server, comprising:
a processor; and
a memory configured to store instructions executable by the processor,
wherein the processor is configured to perform:
receiving a first service registration updating request from a client device;
acquiring services registered with a first contact identification of the client device; and
updating registration information of the services using a second contact identification of the client device.

13. The server of claim 12, wherein acquiring the services registered with the first contact identification of the client device comprises:
acquiring a service list stored locally, which corresponds to the first contact identification using the first contact identification; wherein the service list comprises services acquired from service registration messages received from the client device via the first contact identification and synchronized to the server.

14. The server of claim 13, wherein updating the registration information of the services using the second contact identification of the client device comprises:
sending the service list to the client device.

15. The server of claim 13, wherein updating the registration information of the services using the second contact identification of the client device comprises:
screening out, from the service list, services available for directly executing a service registration update;
sending a second service registration updating request to providers of the screened out services, wherein the second service registration updating request carries the second contact identification; and
sending a service list without the screened out services to the client device.

16. The server of claim 15, wherein screening out the services available for directly executing the service registration update comprises:
traversing through a type of each service in the service list beginning from the first service in the service list; and
screening out services belonging to types available for directly executing the service registration update;
wherein the type available for directly executing the service registration update is marked according to a notation by the client device on the service registration message when services are acquired from service registration messages received from the client device via the first contact identification and synchronized to the server.

17. The server of claiml5, wherein screening out the services available for directly executing the service registration update comprises:
traversing through providers of each service in the service list beginning from the first service in the service list; and
screening out services corresponding to providers in a list available for directly executing the service registration update.

18. The server of claim 15, wherein updating the registration information of the services using the second contact identification of the client device further comprises:
sending a confirmation notice to the client device, wherein the confirmation notice prompts that the service registration update of the services available for directly executing the service registration update will be executed;
receiving a confirmation instruction of the confirmation notice from the client device; and
executing, after receiving the confirmation instruction, a step of sending a second service registration updating request to the providers of the services screened out.
